(19) United States
(12) Patent Application Publication
(10) Pub. No.: US 2017/0236318 A1
(43) Pub. Date: Aug. 17, 2017

(54) Animated Digital Ink

(71) Applicant: Microsoft Technology Licensing, LLC, Redmond, WA (US)

(72) Inventors: Danielle Lauren Ellbogen, Seattle, WA (US); Kelly Rose McArthur, Redmond, WA (US); Sean Gary Nordberg, Bellevue, WA (US); Alexander Bain, Redmond, WA (US); Aaron Michael Getz, Bellevue, WA (US); Francis Zhou, Redmond, WA (US)

(21) Appl. No.: 15/043,874

(22) Filed: Feb. 15, 2016

(51) Int. Cl. G06T 13/80

(52) U.S. Cl. CPC G06T 13/80

(57) ABSTRACT

The digital ink system receives digital ink input from a user and analyzes the digital ink input to collect ink stroke data for the various ink strokes that make up the digital ink. The digital ink system also receives an animation type selection that describes a manner in which the digital ink is to be displayed. The animation type is a dynamic display type, which is display type in which the digital ink changes while the digital ink is displayed. The ink strokes of the digital ink input are displayed using the selected animation type, and are also stored along with the animation type in a digital ink container for subsequent display. The digital ink can be subsequently displayed using the animation type or using a static display type in which the digital ink appears to be stationary while the digital ink is displayed.

### BACKGROUND

Devices today (e.g., computing devices) typically support a variety of different input techniques. For instance, a particular device may receive input from a user via a keyboard, a mouse, voice input, touch input (e.g., to a touchscreen), and so forth. One particularly intuitive input technique enables a user to utilize a touch instrument (e.g., a pen, a stylus, a finger, and so forth) to provide freehand input to a touch-sensing functionality such as a touchscreen, which is interpreted as digital ink. The freehand input may be converted to a corresponding visual representation on a display, such as for taking notes, for creating and editing an electronic document, and so forth.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, digital ink input made up of one or more digital ink strokes is received. An input animation type selection for the digital ink input is also received, and ink stroke data for each of the one or more digital ink strokes is collected. The one or more digital ink strokes of the digital ink input are displayed using the input animation type. The ink stroke data and an indication of the input animation type are also added to a digital ink container, and the digital ink container is communicated to a digital ink store.

In accordance with one or more aspects, a user request to display digital ink made up of one or more digital ink strokes is received. A digital ink store is communicated with to obtain a digital ink container including the digital ink. The one or more digital ink strokes are obtained from the digital ink container, and an input animation type for the digital ink is identified from the digital ink container. The one or more digital ink strokes are displayed using the input animation type in response to the user request.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example environment in which the animated digital ink discussed herein can be used.

FIG. 2 illustrates an example digital ink container in accordance with one or more embodiments.

FIGS. 3 and 4 illustrate examples of different animation types.

FIG. 5 illustrates an example of a static display type.

FIG. 6 is a flowchart illustrating an example process for implementing the animated digital ink in accordance with one or more embodiments.

FIG. 7 is a flowchart illustrating an example process for displaying animated digital ink in accordance with one or more embodiments.

FIG. 8 illustrates an example system that includes an example computing device that is representative of one or more systems and/or devices that may implement the various techniques described herein.

### DETAILED DESCRIPTION

Animated digital ink is discussed herein. A computing device includes a digital ink system that provides digital ink functionality for the computing device. The digital ink system can be implemented as part of an application, as a standalone application that provides digital ink support to other applications, or combinations thereof. Generally, digital ink refers to freehand input to a touch-sensing device such as a touchscreen, which is interpreted by the computing device as digital ink (or simply “ink”). Digital ink may be provided in various ways, such as using a pen (e.g., an active pen, a passive pen, and so forth), a stylus, a finger, and so forth. The digital ink system provides functionality allowing applications to receive digital ink inputs from a user of the computing device, store received digital ink inputs, and display digital ink inputs.

The digital ink system receives digital ink input from a user and analyzes the digital ink input to collect ink stroke data for the various ink strokes that make up the digital ink. This ink stroke data refers to various information describing the digital ink input, such as the coordinates on the input device where the digital ink input occurred and pressure information indicating an amount of pressure applied at each of those coordinates for the digital ink input. The digital ink system also receives an animation type selection. The digital ink system supports multiple different animation types, each of which describes a manner in which the digital ink is to be displayed. The animation types are display types that are dynamic, which refers to the digital ink or area surrounding the digital ink changing (e.g., the digital ink or area surrounding the digital ink appears to be moving) while the digital ink is displayed. Examples of animation types include a fire animation type in which the digital ink appears to be on fire, a glitter animation type in which the digital ink appears to sparkle as if it were glitter, a glow animation type in which the digital ink appears to shine or glow, and so forth.

The digital ink system displays the ink strokes of the digital ink input using the selected animation type. The digital ink system also stores the ink stroke data as well as the animation type selected for the digital ink input (also referred to as the input animation type) in a digital ink container. This digital ink container is stored in a digital ink store, which can be part of or coupled to the computing device at which the digital ink input is received.

The digital ink container can be subsequently obtained by a computing device, and the digital ink included therein displayed on that computing device. The computing device on which the digital ink is displayed can be the computing device on which the digital ink was previously input, or a different computing device. When displaying the digital ink, the digital ink can be displayed using the input animation type. Additionally, the input animation type can be overridden and the digital ink displayed with an override display type rather than the input animation type. The override display type can be another animation type (different from the input animation type) or can be a static display type, which refers to a display type where the digital ink or area surrounding the digital ink does not change (e.g., appears to be stationary) while the digital ink is displayed. Examples of static display types include digital ink that is black or another single color, digital ink that is outlined by a particular color, and so forth.

The techniques discussed herein provide a robust and personal user experience with digital ink. Rather than being limited to a simple black line writing, the techniques discussed herein allow the computing device to provide digital ink that is animated and reflects the user's personality, mood, and so forth. The techniques discussed herein further allow animated digital ink to be displayed on computing devices that do not support digital ink input, or that support digital ink input but not animated digital ink input (referred to as legacy systems or devices below).

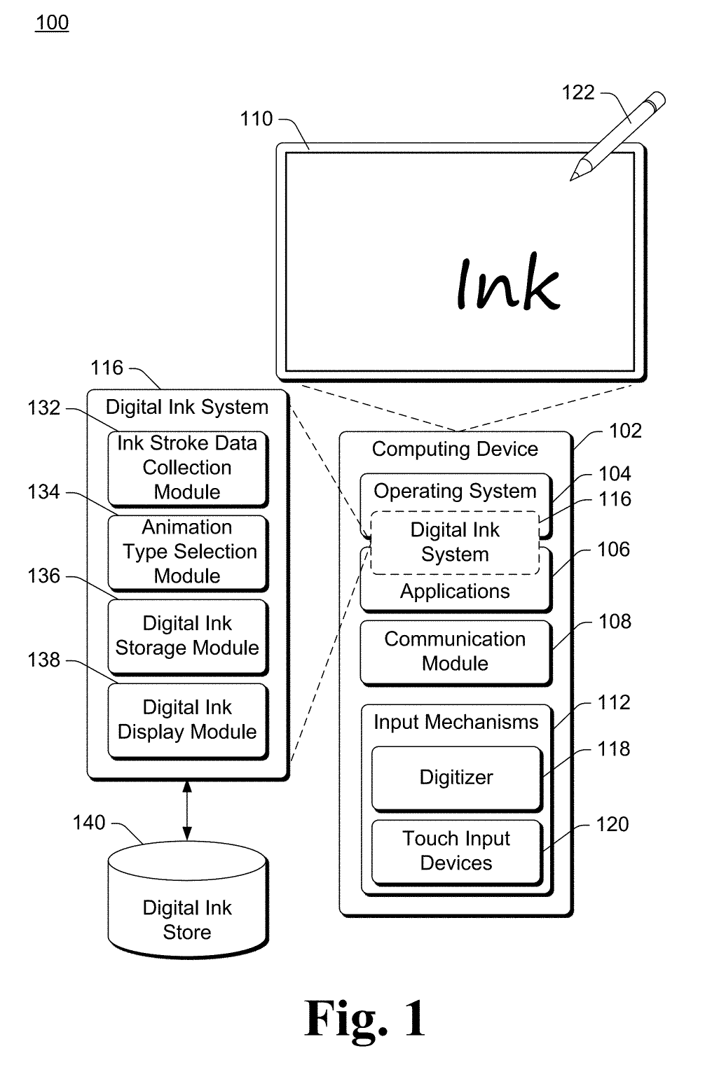

FIG. 1 illustrates an example environment 100 in which the animated digital ink discussed herein can be used. The environment 100 includes a computing device 102 that can be embodied as any suitable device such as, by way of example, a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet), an entertainment device (e.g., an entertainment appliance, a set-top box communicatively coupled to a display device, a game console), an Internet of Things (IoT) device (e.g., objects or things with software, firmware, and/or hardware to allow communication with other devices), a television or other display device, an automotive computer, and so forth. Thus, the computing device 102 may range from a full resource device with substantial memory and processor resources (e.g., personal computers, game consoles) to a low-resource device with limited memory and/or processing resources (e.g., traditional set-top boxes, hand-held game consoles).

The computing device 102 includes a variety of different functionalities that enable various activities and tasks to be performed. For instance, the computing device 102 includes an operating system 104, multiple applications 106, and a communication module 108. Generally, the operating system 104 is representative of functionality for abstracting various system components of the computing device 102, such as hardware, kernel-level modules and services, and so forth. The operating system 104, for instance, can abstract various components of the computing device 102 to the applications 106 to enable interaction between the components and the applications 106.

The applications 106 represent functionalities for performing different tasks via the computing device 102. Examples of the applications 106 include a word processing application, an information gathering and/or note taking application, a spreadsheet application, a web browser, a gaming application, and so forth. The applications 106 may be installed locally on the computing device 102 to be executed via a local runtime environment, and/or may represent portals to remote functionality, such as cloud-based services, web apps, and so forth. Thus, the applications 106 may take a variety of forms, such as locally-executed code, portals to remotely hosted services, and so forth.

The communication module 108 is representative of functionality for enabling the computing device 102 to communicate over wired and/or wireless connections. For instance, the communication module 108 represents hardware and logic for communication via a variety of different wired and/or wireless technologies and protocols.

The computing device 102 further includes a display device 110, input mechanisms 112, and a digital ink system 116. The display device 110 generally represents functionality for visual output for the computing device 102. Additionally, the display device 110 optionally represents functionality for receiving various types of input, such as touch input, pen input, and so forth. The input mechanisms 112 generally represent different functionalities for receiving input to the computing device 102. Examples of the input mechanisms 112 include gesture-sensitive sensors and devices (e.g., such as touch-based sensors and movement-tracking sensors (e.g., camera-based)), a mouse, a keyboard, a stylus, a touch pad, accelerometers, a microphone with accompanying voice recognition software, and so forth. The input mechanisms 112 may be separate or integral with the display 110; integral examples include gesture-sensitive displays with integrated touch-sensitive or motion-sensitive sensors. The input mechanisms 112 optionally include a digitizer 118 and/or touch input devices 120. The digitizer 118 represents functionality for converting various types of input to the display device 110 and/or the touch input devices 120 into digital data that can be used by the computing device 102 in various ways, such as for generating digital ink. The touch input devices 120 represent functionality for providing touch input separately from the display 110.

Although reference is made herein to the display device 110 receiving various types of input such as touch input or pen input, alternatively the display device 110 may not receive such input. Rather, a separate input device (e.g., a touchpad) implemented as a touch input device 120 can receive such input. Additionally or alternatively, the display device 110 may not receive such input, but a pen (such as pen 122) can be implemented as a touch input device 120, and the pen provides an indication of the input rather than the input being sensed by the display device 110.

According to various implementations, the digital ink system 116 represents functionality for performing various aspects of techniques for a cross application digital ink repository discussed herein. Various functionalities of the digital ink system 116 are discussed herein. In one or more embodiments, the digital ink system 116 is implemented as an application 106 (or a program of the operating system 104) that provides animated digital ink support to other applications 106 (or programs of the operating system 104). The digital ink system 116 optionally includes an application programming interface (API) allowing the applications 106 or other programs to interact with the functionality provided by the digital ink system 116. Alternatively, the digital ink system 116 can be implemented in an application 106 and provide animated digital ink support for that application 106 but not for other applications 106. Alternatively, the digital ink system 116 can be implemented as a combination thereof. For example, some functionality of the digital ink system 116 can be implemented in an application 106 (or a program of the operating system 104) that provides animated digital ink support to other applications 106 or programs, and other functionality of the digital ink system 116 can be implemented in the individual applications 106 to which the digital ink system 116 provides support.

The environment 100 further includes a pen 122, which is representative of an input device for providing input to the display device 110. Generally, the pen 122 is in a form factor of a traditional pen but includes functionality for interacting with the display device 110 and other functionality of the computing device 102. In at least some implementations, the pen 122 is an active pen that includes electronic components for interacting with the computing device 102. The pen 122, for instance, includes a battery that can provide power to internal components of the pen 122. Alternatively or additionally, the pen 122 may include a magnet or other functionality that supports hover detection over the display device 110. This is not intended to be limiting, however, and in at least some implementations the pen 122 may be passive, e.g., a stylus without internal electronics.

Digital ink can be input by the user using the pen 122. Additionally or alternatively, digital ink can be input by the user using other input mechanisms, such as the user's finger, a stylus, and so forth.

The digital ink system 116 includes an ink stroke data collection module 132, an animation type selection module 134, a digital ink storage module 136, and a digital ink display module 138.

The ink stroke data collection module 132 collects ink stroke data for digital ink input to the computing device 102. Digital ink is described using ink stroke data, which is various information describing the digital ink input. In one or more embodiments, the ink stroke data includes a set of coordinates and optionally pressure applied at each coordinate. The coordinates can be in various coordinate systems, such as a 2-dimensional Cartesian coordinate system, a polar coordinate system, and so forth. The pressure or force can be measured in various units, such as pascals. The coordinates and optionally pressure can be sensed by various sensors of the touch input devices 120 (e.g., sensors in the display device 110, sensors in the pen 122, and so forth).

The coordinates included in the ink stroke data are a set or series of coordinates that identify the location of the input mechanism at particular times as the digital ink is being input. These particular times can be regular or irregular intervals (e.g., every 10 milliseconds). The coordinates are detected or sensed by the digitizer 118 or a touch input device 120, such as by the display device 110, by the pen 122, and so forth. Using the example of the digital ink input of “Ink” in FIG. 1, the ink stroke data for the digital ink input is the coordinates that identify the location of the input mechanism as the letter “I” is written, as the letter “n” is written, and as the letter “k” is written.

The animation type selection module 134 determines an animation type for digital ink. An animation type refers to a description of the manner in which the digital ink is displayed, including the digital ink itself as well as optionally areas around the digital ink. The animation types are display types that are dynamic and in which the appearance of the digital ink and/or the area surrounding the digital ink, when displayed, is changing. This changing can, for example, make the digital ink appear to be moving while the digital ink is displayed, can make features displayed in areas around the digital ink appear to be moving, and so forth.

Digital ink can also optionally be displayed with a static display type in which the appearance of the digital ink, when displayed, is not changing. For a static display type, the digital ink appears to be stationary while the digital ink is displayed, such as being a single color (e.g., black) that does not change while the digital ink is displayed. In one or more embodiments, for a static display type additional features (such as might be displayed in an area around the digital ink for an animation type) are not displayed in the area around the digital ink.

The animation type selection module 134 can determine an animation type for digital ink in a variety of different manners. In one or more embodiments, the animation type selection module 134 uses a default animation type, which can be set by a user of the computing device (e.g., as a user preference setting), by a designer or distributor of the digital ink system 116, by a designer or distributor of an application 106, and so forth. Additionally or alternatively, the animation type selection module 134 can use a user-selected animation type, such as an animation type selected by user selection of a menu item or button displayed on the display device 110, user selection of a button or switch on the pen 122, voice inputs (e.g., the user speaking the name of the animation type he or she desires to use), and so forth.

In one or more embodiments, the animation type selection module 134 supports both an input animation type and an override display type. The input animation type refers to the animation type for the digital ink determined by the animation type selection module 134 at the time the digital ink is input (e.g., the animation type the user selects when he or she inputs the digital ink). The override display type refers to the display type for the digital ink determined by the animation type selection module 134 at the time the digital ink is displayed and that is different than the input animation type. The override display type can be an animation type or a static display type. For example, a user may select a different display type at the time the digital ink is displayed (e.g., on a later day, on a different computing device than the digital ink was input, etc.) than the animation type that was selected at the time the digital ink was input, and this different display type is referred to as the override display type.

The digital ink storage module 136 generates, or adds to previously generated, digital ink containers. The digital ink storage module 136 stores the digital ink containers in a digital ink store 140. The digital ink store 140 can be implemented using any of a variety of memory or storage devices, such as Flash memory, magnetic disks, optical discs, and so forth. The digital ink store 140 can be situated in any of a variety of locations, such as on the computing device 102, on a service accessed via a network or other connection, on a pen providing the digital ink input (e.g., the pen 122), and so forth. When situated on a service accessed via a network or other connection, the computing device 102 can communicate with one or more computing devices implementing the service via any of a variety of different networks, including the Internet, a local area network (LAN), a public telephone network, an intranet, other public and/or proprietary networks, combinations thereof, and so forth. Additionally or alternatively, the computing device 102 can communicate with one or more computing devices implementing the service via any of a variety of other wired or wireless connections, such as a USB (universal serial bus) connection, a wireless USB connection, an infrared connection, a Bluetooth connection, a DisplayPort connection, a PCI (a peripheral component interconnect) Express connection, and so forth.

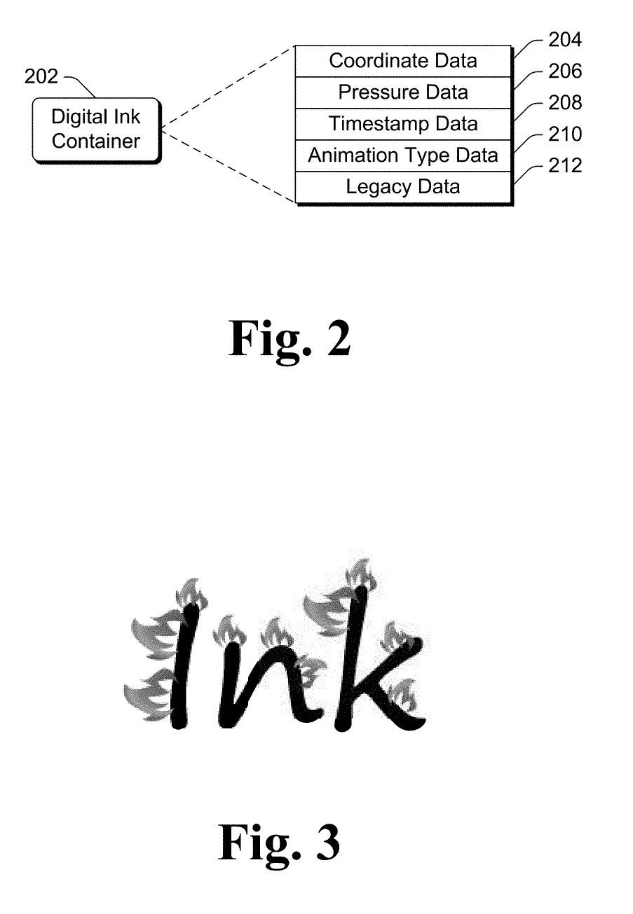

The digital ink storage module 136 stores, in a digital ink container associated with a digital ink input, data allowing the digital ink input to be subsequently retrieved and displayed. FIG. 2 illustrates an example digital ink container 202 in accordance with one or more embodiments. The digital ink container 202 includes coordinate data 204, pressure data 206, timestamp data 208, animation type data 210, and legacy data 212. The coordinate data 204 is the coordinates of the input device where the digital ink input 202 occurred, and the pressure data is an indication of an amount of pressure or force applied for the digital ink input 202. In one or more embodiments, this amount of pressure or force is an amount of pressure or force applied at each of the coordinates in the coordinate data 204. Additionally or alternatively, this amount of pressure or force can take different forms, such as a value representing the pressure applied during the digital ink input (e.g., an average of pressures applied during the digital ink input), an amount of pressure applied at a particular point during the digital ink input (e.g., at the beginning of the digital ink input, at the end of the digital ink input, at a mid-point of the digital ink input), and so forth.

The digital ink container 202 optionally includes timestamp data 208, which is the date and/or time that the digital ink input is received. In one or more embodiments, the timestamp data 208 is for the digital ink input as a whole (e.g., the date and/or time that the digital ink input began or ended). Alternatively, separate timestamp information can be collected for each of the coordinates in the coordinate data 204, the timestamp information for a coordinate comprising the date and/or time that the coordinate was touched or otherwise detected or sensed as part of the digital ink input.

The animation type data 210 is an indication of an animation type for the digital ink. The animation type indicated in the animation type data 210 is the input animation type discussed above.

The digital ink container 202 optionally includes legacy data 212, which is information used to display animated digital ink on devices or systems that do not support or understand the animation type data 210. Such devices or systems are also referred to as legacy systems, and the display of animated digital ink on such devices or systems is discussed in additional detail below.

Returning to FIG. 1, the digital ink storage module 136 can store the digital ink containers in any of a variety of different manners. In one or more embodiments, the digital ink containers are associated with (e.g., embedded in) a page or sheet that is displayed by the application 106 to which the digital ink is input. For example, an application 106 may be a note taking application that stores each page of notes as a separate file (e.g., in a markup language format, such as a HyperText Markup Language (HTML) format), and the digital ink container can be included as part of that file (alternatively, that file can itself can be considered to be the digital ink container). Additionally or alternatively, the digital ink containers can be stored separately from the file in which other data for the application 106 is stored, a digital ink container can be associated with multiple pages or sheets of an application 106, and so forth.

In one or more embodiments, the digital ink container includes legacy information that is stored in a manner that many legacy devices or systems understand. A legacy device or system does not understand the animation type data included in a digital ink container nor how to animate digital ink using the animation type indicated by the animation type data. However, the legacy information can be readily displayed by the legacy devices or systems (those that understand the format of the legacy information). Various different formats can be used to store the legacy information, such as HTML, JavaScript, Scalable Vector Graphics (SVG), and so forth. The digital ink storage module 136 generates an animated version of the digital ink, which is a version of the digital ink display with the input animation type, and stores the animated version of the digital ink in one of these different formats as the legacy information. For example, if the animation type is a fire animation type, then an animated version of the digital ink that appears to be on fire is generated, recorded, and saved as the legacy information. This recording can then be played back by the legacy device or system. The digital ink storage module 136 can optionally generate an animated digital ink display with multiple different animation types, and store each in one of these different formats.

Such legacy devices or systems are thus able to display animated digital ink using the legacy information. It should be noted that in such situations the legacy device or system may not allow for an override display type to be selected. However, if the legacy information in the digital ink container includes information for multiple different animation types, then user selection of one of those multiple types may still be made on a legacy device or system. For example, a digital ink container may include legacy information for three different animation types. The digital ink container can be included in a file for an application 106 that optionally includes additional data to be displayed on a page or sheet of the application 106. The file can include a user-selectable option (e.g., implemented in JavaScript or HTML) that allows the user to select one of the three different animation types. In response to a user selection of one of the three different animation types, the legacy information for the selected animation type is used to display the animated digital ink. Thus, even though the legacy device or system does not directly support animated digital ink, using the legacy information it can be made to appear (and function, from the point of view of the user) as if the legacy device or system does support animated digital ink.

The digital ink display module 138 displays the animated digital ink. This display includes the display of digital ink as the digital ink is input to the computing device 102, as well as the display of digital ink obtained from a digital ink container in the digital ink store 140. The digital ink system 140 can include digital ink containers for digital ink input to the computing device 102 and/or digital ink input to other computing devices 102. Regardless of the computing device on which the digital ink was input, the digital ink display module displays the digital ink with the appropriate display type (e.g., the input animation type or the override display type).

The digital ink display module 138 generates the animation that is determined to be the animation for the digital ink by the animation type selection module 134. The digital ink display module 138 can be programmed or otherwise configured to display different animation types. Additionally or alternatively, the digital ink display module 138 can obtain additional animation types from other sources (e.g., third party developers, an application store accessed via the Internet or other network). Thus, the animation types supported by the digital ink display module 138 are dynamic, with the animation types supported by the digital ink display module 138 being able to change over time.

The digital ink display module 138 can implement the different animation types using any of a variety of different public and/or proprietary techniques. For example, various different rules or algorithms can be used to change the values of pixels on the display device 110 where the digital ink is displayed, and optionally in areas around the digital ink, to provide the appropriate animation.

In one or more embodiments, the digital ink system 116 is implemented in part as a standalone application that provides digital ink functionality to other applications 106, thereby alleviating the other applications 106 of at least some of the burden of providing digital ink support. In such embodiments, the ink stroke data collection module 132 is implemented in the standalone application and operates to collect the ink stroke data for digital ink input to another application 106. The other application 106, however, implements the animation type selection module 134 and the digital ink display module 138 (optionally notifying the standalone application that the additional application 106 is implementing the digital ink display module 138). Thus, the standalone application provides digital ink support to the additional application 106, but the standalone application need not have knowledge of the animation types or of how to implement the different animation types.

In one or more embodiments, the appropriate animation type is implemented so that an animated ink stroke is displayed while the ink stroke is being input. Alternatively, the appropriate animation type is implemented so that an animated ink stroke is displayed after the ink stroke is input (e.g., after the user has lifted the pen 122 or other input device from the touchscreen). In such situations, the animation is not displayed until input of the ink stroke (or optionally multiple ink strokes) have been completed.

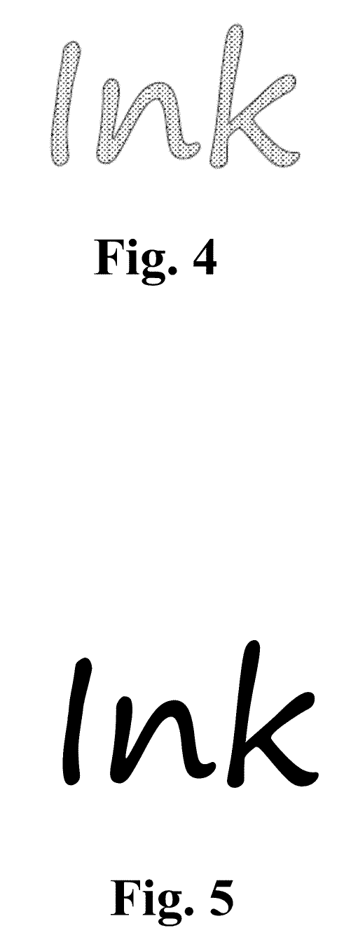

Various different types of animation types can be implemented as discussed above. FIGS. 3 and 4 illustrate examples of different animation types.

FIG. 3 illustrates an example of an animation type that is a fire animation type. In the fire animation type, the digital ink appears to be on fire, such as by having red or orange flames that move over time as the digital ink is displayed and appear to leap from the digital ink. For the fire animation type, the digital ink itself can also be red or orange to give the appearance that the digital ink is on fire. In the example of FIG. 3, the digital ink is the word “ink”, and flames appearing to leap from the digital ink are shown. It should be noted that FIG. 3 illustrates an example of the fire animation type at a given point in time, and that the location of the flames change over time to give the appearance of fire.

FIG. 4 illustrates an example of an animation type that is a glitter animation type. In the glitter animation type, the digital ink appears to sparkle in one or more different colors as if it were glitter. For the glitter animation type, the digital ink itself can appear to sparkle, and the area around the digital ink can optionally appear to sparkle as well (e.g., in a different color than the digital ink). In the example of FIG. 4, the digital ink is the word “ink”, and the dots that make up the letters of the word “ink” represent specks of glitter. It should be noted that FIG. 4 illustrates an example of the glitter animation type at a given point in time, and that the color or brightness of at least some of the dots that make up the letters of the word “ink” change over time to give the appearance of glitter.

The fire animation type and glitter animation type are examples of animation types, and various other animation types can be implemented. Another example of an animation type is a glow animation type in which the digital ink appears to shine or glow (e.g., as a result of changing colors or brightness values). For the glow animation type, the digital ink itself can appear to shine or glow, and the area around the digital ink can optionally appear to shine or glow as well (e.g., in a different color than the digital ink).

Another example of an animation type is a water animation type in which the digital ink appears to be a liquid. The digital ink can be blue or green in color, and can appear to be flowing (e.g., as a river or stream), can appear to have waves, and so forth. For the water animation type, additional liquid features can be displayed in the area around the digital ink (e.g., as if it were sea spray as a result of waves in the digital ink).

Another example of an animation type is a smoke animation type in which the digital ink appears to be smoke. The digital ink can be grey, white, or black, and can change over time to give the appearance that the digital ink is smoke (e.g., moving in the wind, dissipating, etc.). For the smoke animation type, additional smoke features can be displayed in the area around the digital ink, such as additional clouds or puffs of smoke that appear to be billowing from the digital ink.

Another example of an animation type is an abstract animation type in which various geometric shapes or designs are used for the digital ink or the area around the digital ink. For example, the digital ink could be the colors of a rainbow (which may change, with different portions of the digital ink being different colors of a rainbow at different times) and stars can be displayed in the area around the digital ink. By way of another example, the digital ink may change colors while displayed, may fade in and out (or portions of the digital ink may fade in and out), and so forth.

FIG. 5 illustrates an example of a static display type that is a solid color display type. In the solid color display type, the digital ink is displayed in a single color (e.g., black, blue, red, or some other color). For a solid color display type, the color of the digital ink remains the same while displayed. Additionally, for a solid color display type, additional features (such as might be displayed in an area around the digital ink for an animation type) are not displayed in the area around the digital ink.

The solid color display type is an example of a static display type, and various other static display types can be implemented. Another example of a static display type is a multi-color display type in which the digital ink is displayed in multiple colors (e.g., different letters or different characters having different colors). For a multi-color color display type, the color of the digital ink remains the same while displayed. Additionally, for a multi-color display type, additional features (such as might be displayed in an area around the digital ink for an animation type) are not displayed in the area around the digital ink.

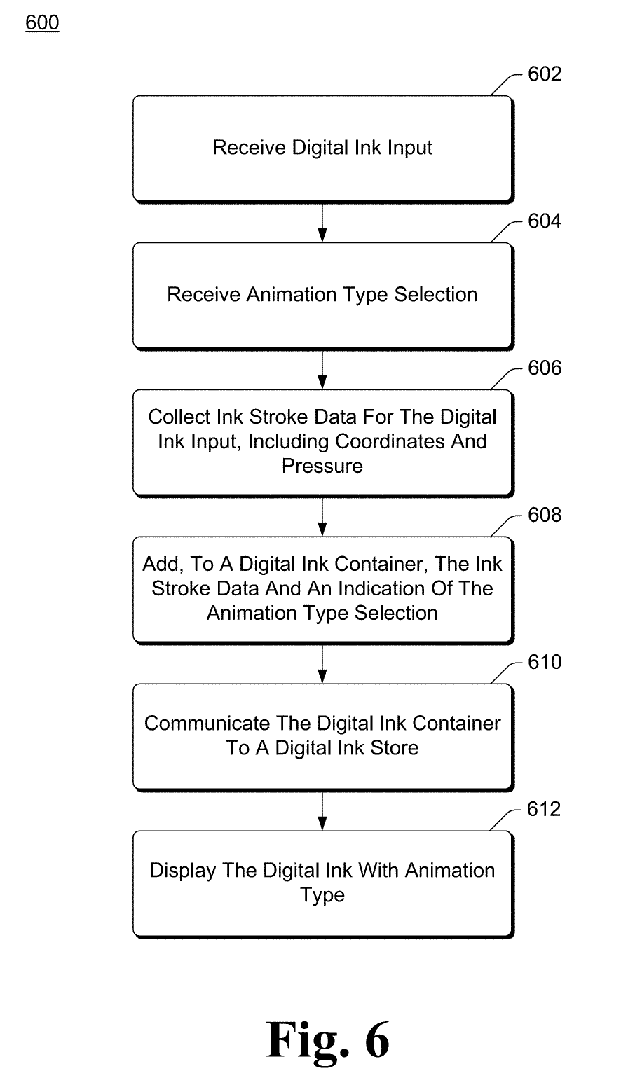

FIG. 6 is a flowchart illustrating an example process 600 for implementing the animated digital ink in accordance with one or more embodiments. Process 600 is carried out by a computing device, such as the computing device 102 of FIG. 1, and can be implemented in software, firmware, hardware, or combinations thereof. Process 600 is shown as a set of acts and is not limited to the order shown for performing the operations of the various acts. Process 600 is an example process for implementing the animated digital ink; additional discussions of implementing the animated digital ink are included herein with reference to different figures.

In process 600, a digital ink input is received (act 602). The digital ink input can be input directly to an application and provided to a digital ink system, or can be provided to a digital ink system that receives the digital ink input on behalf of the application.

An animation type selection is also received (act 604). The animation type selection can be input directly to an application and provided to a digital ink system, or can be provided to a digital ink system that receives the animation type selection on behalf of the application. The animation type selection can be made in various manners as discussed above, such as user selection of a menu item or button, a default selection, and so forth.

Ink stroke data for the digital ink input is collected (act 606). This ink stroke data includes coordinates that identify the location of the input mechanism at particular times as the digital ink is being input, as well as pressure data for the digital ink input, as discussed above.

The ink stroke data as well as an indication of the animation type selection is added to a digital ink container (act 608). The indication of the animation type selection is an indication of the input animation type. Additional information can also optionally be included in the digital ink container, such as legacy information as discussed above.

The digital ink container is communicated to a digital ink store (act 610). The digital ink store can be implemented on the same computing device as the computing device implementing the process 600, or alternatively a different computing device.

The digital ink is also displayed using the animation type (act 612). The animation type is the animation type selected in act 604. In one or more embodiments, the user can change the animation type while the digital ink is displayed, resulting in the digital ink being displayed with an animation type other than the input animation type (e.g., an override display type).

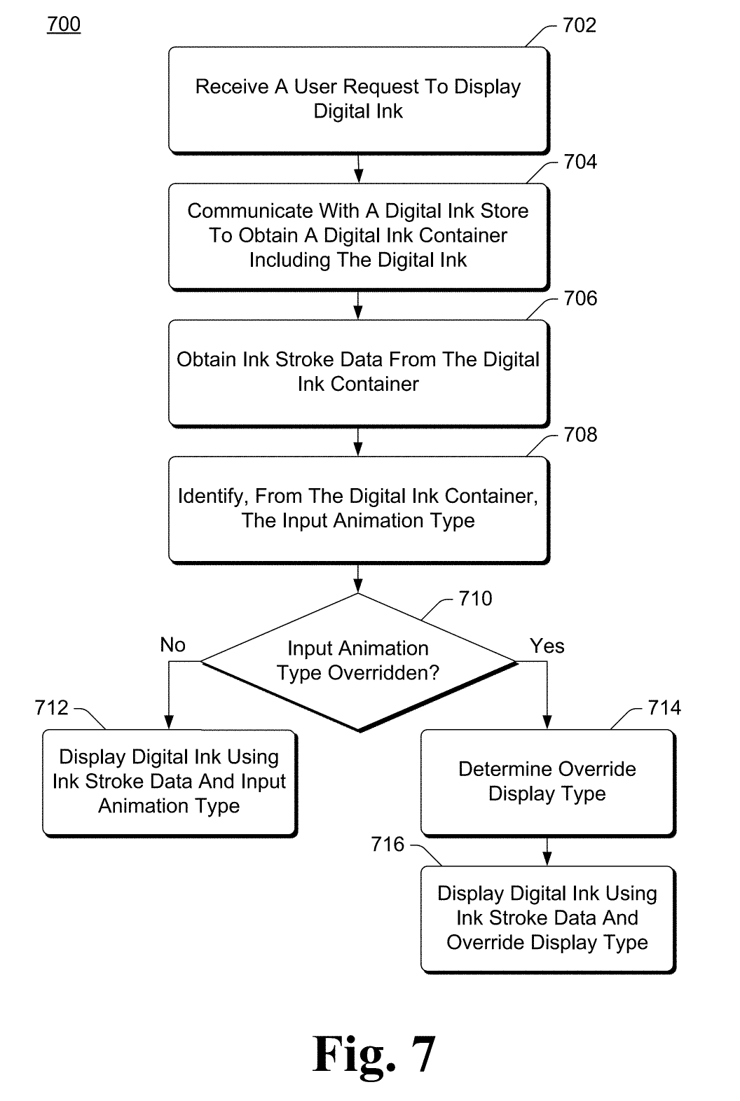

FIG. 7 is a flowchart illustrating an example process 700 for displaying animated digital ink in accordance with one or more embodiments. Process 700 is carried out by a computing device, such as the computing device 102 of FIG. 1, and can be implemented in software, firmware, hardware, or combinations thereof. Process 700 is shown as a set of acts and is not limited to the order shown for performing the operations of the various acts. Process 700 is an example process for displaying animated digital ink; additional discussions of displaying animated digital ink are included herein with reference to different figures.

In process 700, a user request to display digital ink input is received (act 702). The user request can be received in any of a variety of manners, such as by user selection of a particular file that includes digital ink, user selection of particular digital ink from a list or search results, user selection of a page or sheet that includes digital ink, and so forth.

A digital ink store is communicated with to obtain a digital ink container that includes the digital ink (act 704). The digital ink container includes coordinate and optionally pressure data for the digital ink, as well as an indication of the input animation type as discussed above.

Ink stroke data for the digital ink is obtained from the ink stroke data (act 706). The input animation type is also identified from the digital ink container (act 708).

A determination is made as to whether the input animation type is overridden (act 710). The input animation type can be overridden in various manners, such as by the user inputting a request to override the input animation type (e.g., selecting an “override” button or menu item), by the user requesting a different display type (a static display type or an animation type that is different than the input animation type). User selection of this different display type can be performed in any of a variety of different manners, analogous to the selection of the input animation type discussed above. For example, a set of display type options (e.g., buttons, menu items, etc.) can be displayed and the user can select from the set display type options which static display type or animation type he or she desires.

If the input animation type is not overridden, then the digital ink is displayed using the ink stroke data and the input animation type (act 712).

However, if the input animation type is overridden, then a determination is made as to what the override display type is (act 714). The override display type can be a display type selected by the user to indicate to override the input animation type as determined in act 710. The override display type can be an animation type or a static display type. If not selected in act 710, the override display type can be determined in any of a variety of different manners analogous to the selection of the input animation type discussed above (e.g., menu item selections, button selections, voice inputs, and so forth).

The digital ink is displayed using the ink stroke data and the override display type (act 716). Thus, when an override display type is selected, the digital ink is displayed using the selected override display type rather than the input animation type.

It should be noted that acts 714 and 716 can optionally be repeated. In such situations, additional selections of override display types can be made. These selections can be made in any of a variety of different manners analogous to the selection of the input animation type discussed above. The user can thus cycle through different animation types or static display types as he or she desires.

The ability to override the input animation type supports various usage scenarios. For example, a student may choose to write his homework assignment using a fire animation type, but the teacher can choose to override the fire animation type and use a single color static display type when grading the homework assignment.

The techniques discussed herein provide further improved usability of a computing device by allowing users to provide digital ink that is animated and reflects the user's personality or mood, that has a desired effect on its audience, and so forth. The user is able to be more creative in the presentation of digital ink than by using single colors if he or she so chooses. The inherent difficulty in drawing or creating such animations for users that are artistically challenged is overcome by using the animated digital ink discussed herein.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

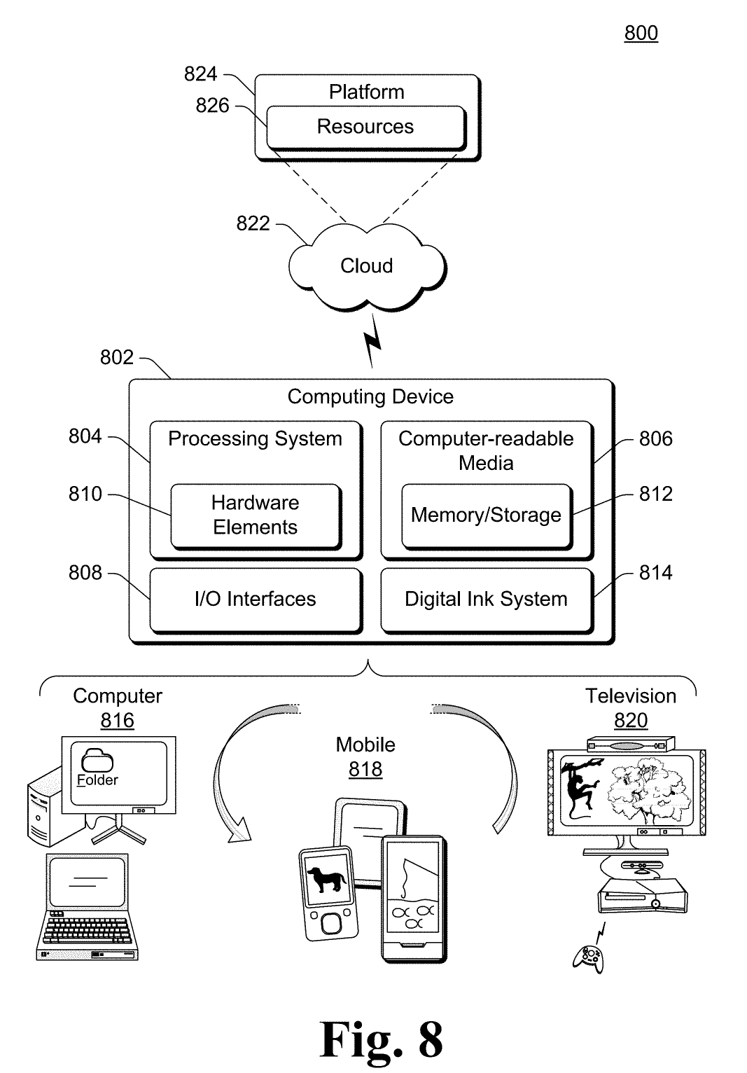

FIG. 8 illustrates an example system generally at 800 that includes an example computing device 802 that is representative of one or more systems and/or devices that may implement the various techniques described herein. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O Interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

The one or more input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 802 may be configured in a variety of ways as further described below to support user interaction.

The computing device 802 also includes a digital ink system 814. The digital ink system 814 provides various functionality supporting animated digital ink as discussed above. The digital ink system 814 can be, for example, the digital ink system 116 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 810 and computer-readable media 806 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of modules as a module that is executable by the computing device 802 as software may be achieved at least partially in hardware, e.g., through use of computer-readable storage media and/or hardware elements 810 of the processing system. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 802 may assume a variety of different configurations, such as for computer 816, mobile 818, and television 820 uses. Each of these configurations includes devices that may have generally different constructs and capabilities, and thus the computing device 802 may be configured according to one or more of the different device classes. For instance, the computing device 802 may be implemented as the computer 816 class of a device that includes a personal computer, desktop computer, a multi-screen computer, laptop computer, netbook, and so on.

The computing device 802 may also be implemented as the mobile 818 class of device that includes mobile devices, such as a mobile phone, portable music player, portable gaming device, a tablet computer, a multi-screen computer, and so on. The computing device 802 may also be implemented as the television 820 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. This functionality may also be implemented all or in part through use of a distributed system, such as over a “cloud” 822 via a platform 824 as described below.

The cloud 822 includes and/or is representative of a platform 824 for resources 826. The platform 824 abstracts underlying functionality of hardware (e.g., servers) and software resources of the cloud 822. The resources 826 may include applications and/or data that can be utilized while computer processing is executed on servers that are remote from the computing device 802. Resources 826 can also include services provided over the Internet and/or through a subscriber network, such as a cellular or Wi-Fi network.

The platform 824 may abstract resources and functions to connect the computing device 802 with other computing devices. The platform 824 may also serve to abstract scaling of resources to provide a corresponding level of scale to encountered demand for the resources 826 that are implemented via the platform 824. Accordingly, in an interconnected device embodiment, implementation of functionality described herein may be distributed throughout the system 800. For example, the functionality may be implemented in part on the computing device 802 as well as via the platform 824 that abstracts the functionality of the cloud 822.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method comprising: receiving digital ink input made up of one or more digital ink strokes; receiving an input animation type selection for the digital ink input; collecting ink stroke data for each of the one or more digital ink strokes; displaying, using the input animation type, the one or more digital ink strokes of the digital ink input; adding, to a digital ink container, the ink stroke data and an indication of the input animation type; and communicating the digital ink container to a digital ink store.

Alternatively or in addition to any of the above described methods, any one or combination of: the ink stroke data including coordinates of an input device where the digital ink input occurs; the ink stroke data further including pressure applied at the coordinates while the digital ink input occurs; the method further comprising adding to the digital ink container legacy data, the legacy data comprising an animated version of the digital ink that can be displayed; the displaying comprising displaying the one or more digital ink strokes using the input animation type as the digital ink input is being received; the method further comprising receiving, after ceasing displaying of the one or more digital ink strokes, a user request to display the digital ink, obtaining the one or more digital ink strokes from the digital ink container, identifying, from the digital ink container, the input animation type, and displaying, in response to the user request, the one or more digital ink strokes using the input animation type; the method further comprising determining whether the input animation type is overridden, and displaying, in response to determining that the input animation type is overridden, the one or more digital ink strokes using an override display type rather than using the input animation type; the method further comprising receiving, after ceasing displaying of the one or more digital ink strokes, a user request to display the digital ink, obtaining the one or more digital ink strokes from the digital ink container, determining an override display type that is a static display type, and displaying, in response to the user request, the one or more digital ink strokes using the override display type rather than using the input animation type.

A computing device comprising: one or more processors; and a computer-readable storage medium having stored thereon multiple instructions that, responsive to execution by the one or more processors, cause the one or more processors to perform acts comprising: receiving a user request to display digital ink made up of one or more digital ink strokes; communicating with a digital ink store to obtain a digital ink container including the digital ink; obtaining the one or more digital ink strokes from the digital ink container; identifying, from the digital ink container, an input animation type for the digital ink; and displaying, in response to the user request, the one or more digital ink strokes using the input animation type.

Alternatively or in addition to any of the above described computing devices, any one or combination of: the acts further comprising determining whether the input animation type is overridden, and in response to determining that the input animation type is overridden determining an override display type, and displaying the one or more digital ink strokes using the override display type rather than using the input animation type; the acts further comprising receiving, after displaying the one or more digital ink strokes using the override display type, a selection of an additional animation type, and displaying the one or more digital ink strokes using the additional animation type rather than using the override display type; the override display type comprising a static display type; the acts further comprising receiving, after displaying the one or more digital ink strokes using the input animation type, a selection of an additional animation type, and displaying the one or more digital ink strokes using the additional animation type rather than using the input animation type; the animation type being one of a fire animation type, a water animation type, or a smoke animation type.

A system comprising: one or more storage devices configured to implement a digital ink store; and a digital ink system configured to receive from an input device an input of digital ink, receive an input animation type selection for the digital ink, collect ink stroke data for each of one or more digital ink strokes of the digital ink, display the one or more digital ink strokes using the input animation type, and add the ink stroke data and an indication of the input animation type to a digital ink container in the digital ink store.

Alternatively or in addition to any of the above described systems, any one or combination of: the ink stroke data including coordinates of the input device where the digital ink input occurs; the digital ink system being further configured to add to the digital ink container legacy data, the legacy data comprising an animated version of the digital ink that can be displayed by a device that does not understand the input animation type; the digital ink system being further configured to receive, after ceasing display of the one or more digital ink strokes, a user request to display the digital ink, obtain the one or more digital ink strokes from the digital ink container, identify, from the digital ink container, the input animation type, and display, in response to the user request, the one or more digital ink strokes using the input animation type; the digital ink system being further configured to determine whether the input animation type is overridden, and display, in response to determining that the input animation type is overridden, the one or more digital ink strokes using an override display type rather than using the input animation type, the digital ink system being further configured to receive, after ceasing display of the one or more digital ink strokes, a user request to display the digital ink, obtain the one or more digital ink strokes from the digital ink container, determine an override display type that is a static display type, and display, in response to the user request, the one or more digital ink strokes using the override display type rather than using the input animation type.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving digital ink input made up of one or more digital ink strokes;
receiving an input animation type selection for the digital ink input;
collecting ink stroke data for each of the one or more digital ink strokes;
displaying, using the input animation type, the one or more digital ink strokes of the digital ink input;
adding, to a digital ink container, the ink stroke data and an indication of the input animation type; and
communicating the digital ink container to a digital ink store.

2. The method of claim 1, the ink stroke data including coordinates of an input device where the digital ink input occurs.

3. The method of claim 2, the ink stroke data further including pressure applied at the coordinates while the digital ink input occurs.

4. The method of claim 1, further comprising adding to the digital ink container legacy data, the legacy data comprising an animated version of the digital ink that can be displayed.

5. The method of claim 1, the displaying comprising displaying the one or more digital ink strokes using the input animation type as the digital ink input is being received.

6. The method of claim 1, the method further comprising:
receiving, after ceasing displaying of the one or more digital ink strokes, a user request to display the digital ink;
obtaining the one or more digital ink strokes from the digital ink container;
identifying, from the digital ink container, the input animation type; and
displaying, in response to the user request, the one or more digital ink strokes using the input animation type.

7. The method of claim 6, the method further comprising:
determining whether the input animation type is overridden; and
displaying, in response to determining that the input animation type is overridden, the one or more digital ink strokes using an override display type rather than using the input animation type.

8. The method of claim 1, the method further comprising:
receiving, after ceasing displaying of the one or more digital ink strokes, a user request to display the digital ink;
obtaining the one or more digital ink strokes from the digital ink container;
determining an override display type that is a static display type; and
displaying, in response to the user request, the one or more digital ink strokes using the override display type rather than using the input animation type.

9. A computing device comprising:
one or more processors; and
a computer-readable storage medium having stored thereon multiple instructions that, responsive to execution by the one or more processors, cause the one or more processors to perform acts comprising:
receiving a user request to display digital ink made up of one or more digital ink strokes;
communicating with a digital ink store to obtain a digital ink container including the digital ink;
obtaining the one or more digital ink strokes from the digital ink container;
identifying, from the digital ink container, an input animation type for the digital ink; and
displaying, in response to the user request, the one or more digital ink strokes using the input animation type.

10. The computing device of claim 9, the acts further comprising:
determining whether the input animation type is overridden; and
in response to determining that the input animation type is overridden:
determining an override display type; and
displaying the one or more digital ink strokes using the override display type rather than using the input animation type.

11. The computing device of claim 10, the acts further comprising:
receiving, after displaying the one or more digital ink strokes using the override display type, a selection of an additional animation type; and
displaying the one or more digital ink strokes using the additional animation type rather than using the override display type.

12. The computing device of claim 10, the override display type comprising a static display type.

13. The computing device of claim 9, the acts further comprising:
receiving, after displaying the one or more digital ink strokes using the input animation type, a selection of an additional animation type; and
displaying the one or more digital ink strokes using the additional animation type rather than using the input animation type.

14. The computing device of claim 9, the animation type being one of a fire animation type, a water animation type, or a smoke animation type.

15. A system comprising:
one or more storage devices configured to implement a digital ink store; and
a digital ink system configured to receive from an input device an input of digital ink, receive an input animation type selection for the digital ink, collect ink stroke data for each of one or more digital ink strokes of the digital ink, display the one or more digital ink strokes using the input animation type, and add the ink stroke data and an indication of the input animation type to a digital ink container in the digital ink store.

16. The system of claim 15, the ink stroke data including coordinates of the input device where the digital ink input occurs.

17. The system of claim 15, the digital ink system being further configured to add to the digital ink container legacy data, the legacy data comprising an animated version of the digital ink that can be displayed by a device that does not understand the input animation type.

18. The system of claim 15, the digital ink system being further configured to:
receive, after ceasing display of the one or more digital ink strokes, a user request to display the digital ink;
obtain the one or more digital ink strokes from the digital ink container;
identify, from the digital ink container, the input animation type; and
display, in response to the user request, the one or more digital ink strokes using the input animation type.

19. The system of claim 18, the digital ink system being further configured to:
determine whether the input animation type is overridden; and
display, in response to determining that the input animation type is overridden, the one or more digital ink strokes using an override display type rather than using the input animation type.

20. The system of claim 15, the digital ink system being further configured to:
receive, after ceasing display of the one or more digital ink strokes, a user request to display the digital ink;
obtain the one or more digital ink strokes from the digital ink container;
determine an override display type that is a static display type; and
display, in response to the user request, the one or more digital ink strokes using the override display type rather than using the input animation type.
